(19) United States
(12) Patent Application Publication
(10) Pub. No.: US 2004/0180315 A1
(43) Pub. Date: Sep. 16, 2004

(54) Training system & method

(76) Inventors: Shane A. Toohey, Dee Why (AU); Ian Schubach, Dee Why (AU)

Correspondence Address: Ladas & Parry, 26 West 61 Street, New York, NY, 10023, US

(21) Appl. No.: 10/730,375

(22) Filed: Dec. 8, 2003

(30) Foreign Application Priority Data
Mar. 14, 2003 (AU) 2003901192

(51) Int. Cl. G09B 5/00; G09B 7/00

(52) U.S. Cl. 434/307 R; 434/322

(57) ABSTRACT

A training system adapted to simulate an outdoor adventure type experience through the medium of interactive audio-visual material adapted to present to users of said system sequences of events; said events potentially leading to a predefined nominal goal and a user-selected actual goal, and wherein said users select responses to said events so as to attempt to optimize conditions conducive to the achieving of said nominal goal and said actual goal.

The present invention relates to the training of corporate managerial and other staff, directed at personal development, character building and improved problem solving abilities and, more particularly, to training systems involving the subjection of participants to challenging, but non-business related environments.

### BACKGROUND

Recent years have seen an increasing appreciation of the value of training systems which take corporate personnel out of the normal office and business world and subject them to a challenging environment. Frequently this will involve a period spent in some outdoor adventure type of activity where individuals, or more usually, groups of individuals are required to strive towards the achievement of a predetermined goal.

Typically a training session may involve the traversing of a route or routes over more or less difficult terrain and include a more or less structured sequence of obstacles and problem situations which have to be overcome.

A number of disadvantages may be identified as associated with these forms of training sessions. Firstly, a group of participants will almost certainly comprise a range of ages and physiques so that members of the group will in effect be confronted with differences in degree of difficulty in some situations stemming from greater or lesser physical ability. This may make a fair assessment of performance across the group or between groups difficult, and may in some situations even jeopardize the success of the training session as a whole.

A further disadvantage is that there is little control over the variables of the physical environment in which the training session is placed. The weather, state of creeks and rivers, ground conditions and other factors such as may cause delays or even injury are largely indeterminate.

Yet a further disadvantage resides in the not inconsiderable costs and inconvenience associated with these training systems. The burden imposed by the removal of often key personnel from a company's operation for the relatively extended period required, their transport, accommodation and insurance as well as the cost of the training session itself is considerable and may place such training beyond the resources of smaller companies.

It is an object of the present invention to ameliorate or provide a solution to these disadvantages or at least to provide a useful alternative.

### BRIEF DESCRIPTION OF INVENTION

Accordingly, in one broad form of the invention there is provided a training system adapted to simulate an outdoor adventure type experience through the medium of interactive audio-visual material adapted to present to users of said system sequences of events; said events potentially leading to a predefined nominal goal and a user-selected actual goal, and wherein said users select responses to said events so as to attempt to optimize conditions conducive to the achieving of said nominal goal and said actual goal.

Preferably said outdoor adventure type experience is a training session, said session comprised of any one of a multiplicity of alternative strings of sequences of events; any one of said strings determined by the selection of one of at least two possible responses by said user to sequential ones of said events.

Preferably said user is an individual.

Preferably said user is a group of individuals.

Preferably said outdoor adventure type experience includes a planning phase wherein said user-selected actual goal is selected from a predetermined group of possible actual goals presented by said system to said user.

Preferably said planning phase includes the selection by said users of predefined numbers of entities from each of predefined groups of entities, said groups including:

(a) virtual participants to act as proxies for said users,

(b) virtual supplies,

(c) virtual items of equipment.

Preferably said audio-visual material is incorporated in a software program adapted for processing on a personal computer.

Preferably said audio-visual material is incorporated in a software program adapted for processing on a network of personal computers.

Preferably said audio-visual material is in the form of digital data on a Compact Disc Read-Only Memory (CD ROM).

Preferably said audio-visual material is in the form of digital data incorporated on a Digital Video Disc (DVD).

Preferably said audio-visual material is in the form of digital data adapted for processing by a virtual reality system.

In a further broad form of the invention there is provided a method for the training of users utilizing a training system, said training system comprising interactive audio-visual material simulating an outdoor adventure type experience having a predefined set goal and a user-selected goal, said material presented in a planning phase and an execution phase, said method including the steps of:

(a) displaying said material via audio-visual equipment

(b) said users selecting a user-selected goal from a number of predefined goals during said planning phase

(c) said users during said planning phase selecting from predefined groups of entities

(d) the presentation to said users during said execution stage of a sequence of events, each event of said sequence of events accompanied by at least two possible choices of response to said event selectable by said users.

Preferably said groups of entities include:

(a) virtual participants in said outdoor type adventure experience

(b) items of supplies relevant to said outdoor type experience

(c) items of equipment relevant to said outdoor type experience

Preferably said sequence of events is one of a multiplicity of possible sequences determined by the selection of said response to each one of said events by said users.

Preferably said selection of said responses determines the realization of said predefined set goal and said user-selected goal.

Preferably said selection of said responses determines the level of achievement of users of said training system.

Preferably said selection of said response is recorded for subsequent analysis and feedback to said users.

### BRIEF DESCRIPTION OF DRAWINGS

Embodiments of the present invention will now be described with reference to the accompanying drawings wherein:

FIG. 1 is a representation of a first embodiment of a training system according to the invention,

FIG. 2 is a representation of a second embodiment of a training system of FIG. 1,

FIG. 3 is a representation of a third embodiment of a training system of FIG. 1,

FIG. 4 is a schematic of the phases of a training system according to the invention,

FIG. 5 is a schematic of the execution of a phase of the training system of FIG. 4.

FIG. 6 is a representation of a further preferred embodiment of a training system according to the invention.

### DETAILED DESCRIPTION OF PREFERRED EMBODIMENTS

In a broad form of the present invention, a training system is provided as a multi-media based interactive virtual environment representing an outdoor adventure type of activity such as, for example, a mountain climbing expedition. The characteristics of participant interaction with the training material are adapted to provide coherent and consistent decision making options and facilitate analysis of individual participant or group performances for evaluation and feedback. The multi-media material may be provided on a number of hardware platforms including DVD players with data projectors or television screen displays; computer systems utilizing on-board or server distributed software programs, CD ROMs or DVDS; as digital transmission over the Internet to remote computers or computer networks; and virtual reality systems.

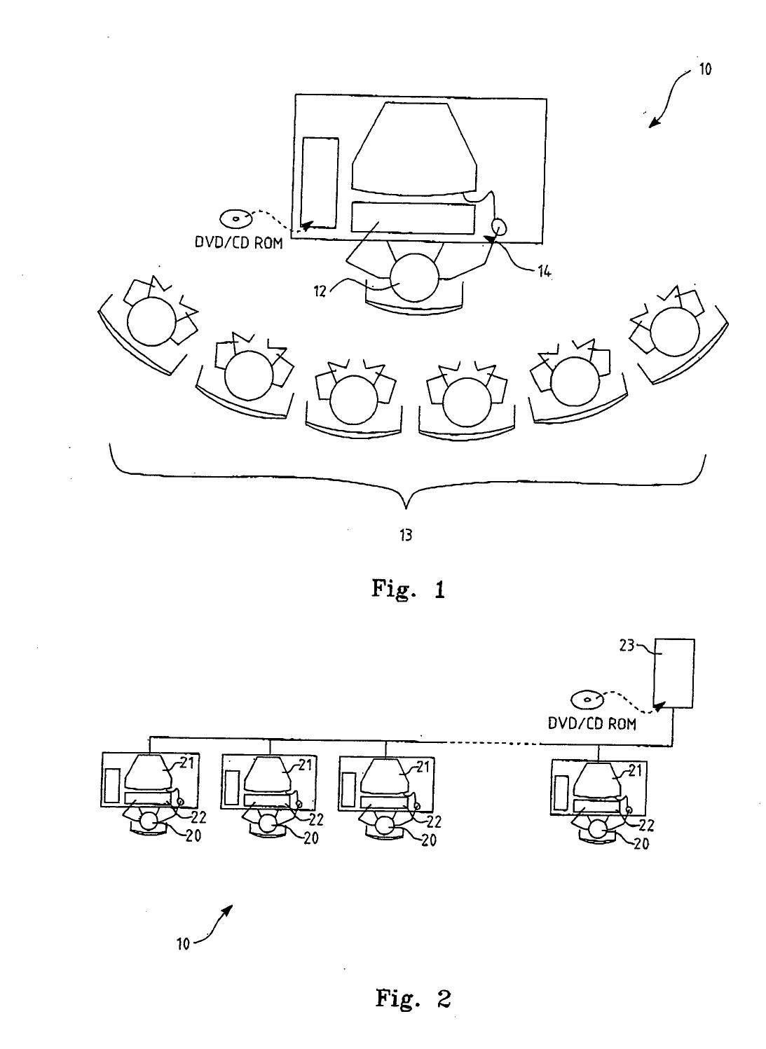

With reference to FIG. 1, a first preferred embodiment of a training system 10 according to the invention is structured so as to allow group participation via a single stand-alone display unit 11 screen. In this first embodiment the display 11 may be the monitor of a personal computer or a television screen, or a data projector and screen connected to a DVD player. The lead facilitator operates a display interface, for example a keyboard and mouse 14 in the case of a computer-based system or a remote control for a television screen, data projection screen and DVD player system. The group participates in the decision making process, determining responses and inputs to the system. A training session may include a number of such constituted groups of participants, each group clustered around a stand-alone display unit and its interface, or watching the whole series of different teams' decisions come to life on the screen.

In a second preferred embodiment of the invention as illustrated in FIG. 2, the training system 10 may accommodate a number of individual participants 20, each having access to his or her own computer monitor 21 and interface 22 linked to a common system server 23. The training material may in this embodiment be adapted so that all participants share a common multimedia experience with decisions made on a consensus basis. This arrangement will allow a method of group decision making which may include the tracking of individual inputs to that process for subsequent evaluation and feed-back. Alternatively, the training experience may progress individually for each participant according to his or her handling of the presented material.

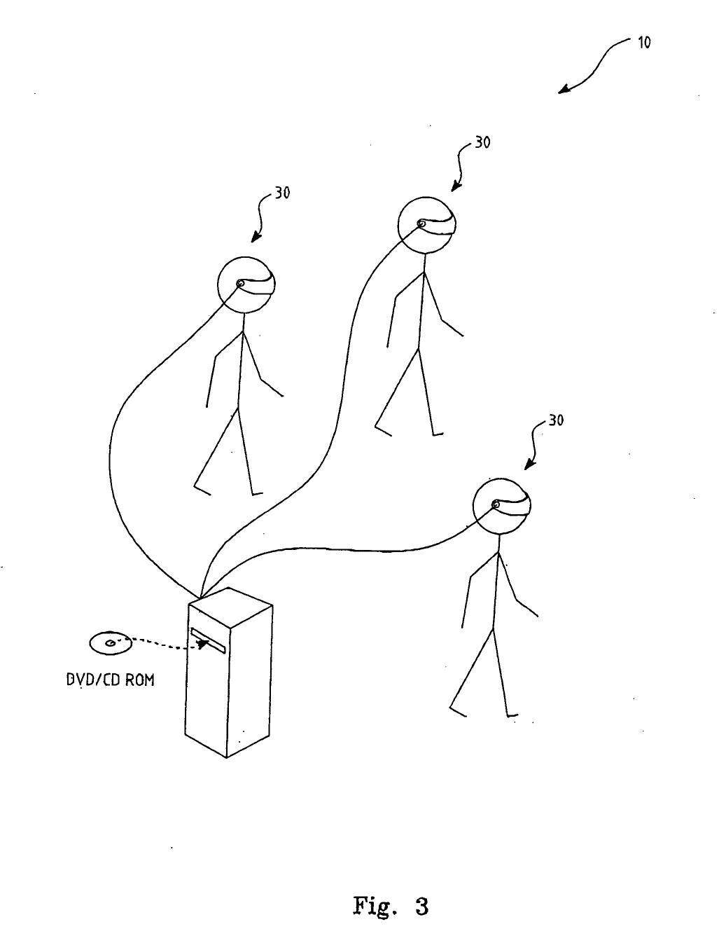

In a third preferred embodiment of the present invention illustrated in FIG. 3, the training system includes a multi-user virtual reality system where participants are provided with individual wearable audio-visual equipment 30. Training may be structured as a group activity with consensus decision making by the group or as individuals.

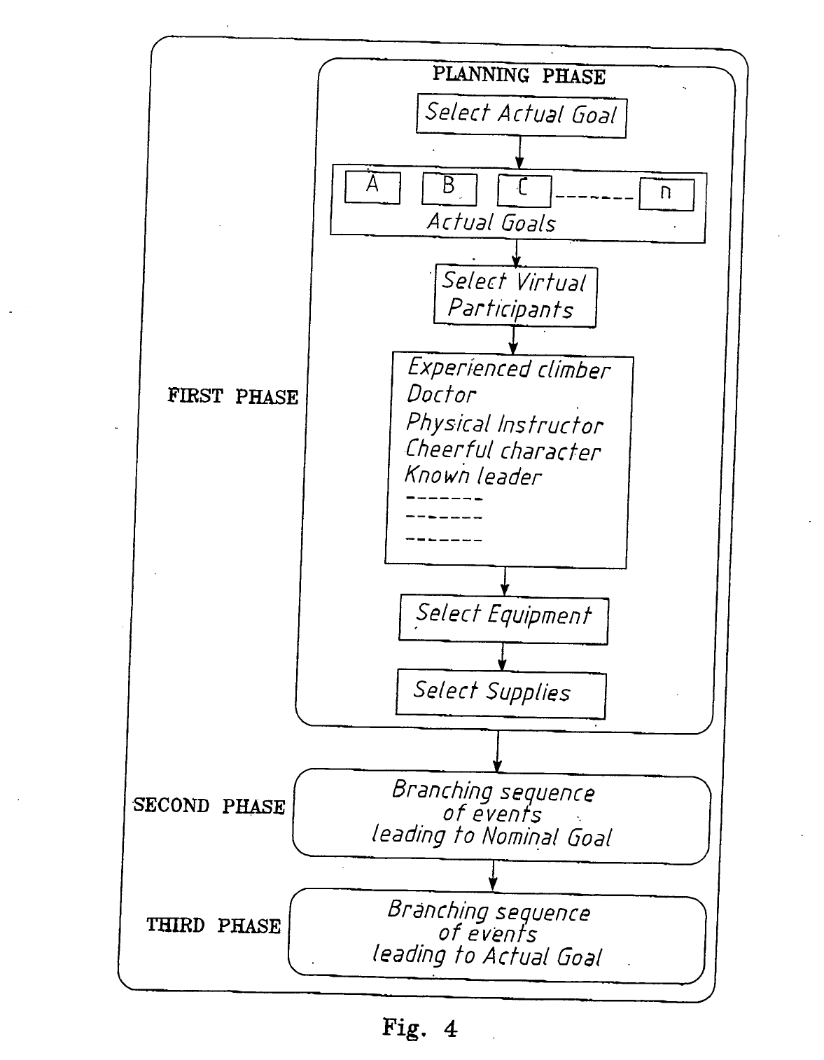

Regardless of the method of delivery of the hardware platform, the training material for a given training session as presented in any of the above described embodiments has the same basic structure as illustrated in FIG. 4 comprising three phases; a planning phase and two adventure activity phases.

The planning phase requires the participants in a training session to make a selection of at least one of a set of possible actual goals to be achieved subsequent to the predefined nominal goal of the training session. Where the participants of a training session consist of groups of individuals, each group may choose the same or a different actual goal according to preference, although all groups will strive to achieve the set nominal goal. Similarly, if the training session participants are individuals rather than groups, each individual participant may select an actual goal according to preference but will strive to achieve the set nominal goal.

Thus by way of example, if the nominal goal is the ascent of a virtual mountain, participants may select as an actual goal the minimum time taken to reach the nominal goal and return to base regardless of cost in personnel or equipment, or the reaching of the nominal goal and return without injury, or yet again by way of example, the reaching of the goal and return by a more arduous but otherwise rewarding route.

The planning phase may include the selection of a team of “virtual participants” who will take part in the adventure activity as proxies for the “actual participants” in the training session. Selection may be made according to preferred skills and attributes of available virtual participants, in the light of the likely problems to be expected from achieving the nominal and actual goals. Again by way of example, the goal of climbing a mountain would make the selection of an experienced climber, if available, of potential advantage to the team of virtual participants (and hence to the actual participants).

The planning phase could also for example include the selection of virtual supplies and such of available virtual equipment most suitable to the goals to be achieved.

This first phase is intended as a test of, and as a development tool for, strategic thinking by the actual participants analogous to the development of for example, a business plan where the limited resources of personnel, budgetary constraints and company infrastructure etc. have to be balanced against a desired outcome.

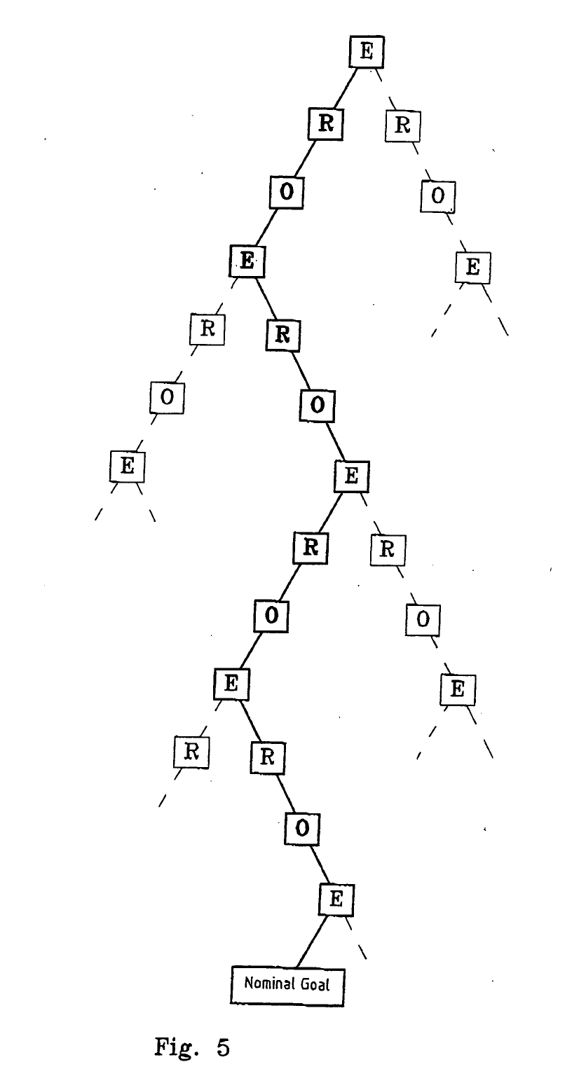

FIG. 5 illustrates the basic structure of each of the two adventure activity phases. They consist of the presentation to participants, whether as a group or as individuals, of a sequence of situations or events “E” which require the participant to make one of at least two possible responses “R”. Each of the responses will lead to a specific outcome “O” triggering a further event unique to the previously selected response and will again require, in turn, the selection of one of at least two possible responses. Any one path through this branching structure of sequences of events and outcomes as determined by participant responses forms a unique virtual presentation of an adventure type of activity leading potentially to the predefined nominal goal for the first adventure activity phase and the actual goal for the second adventure activity phase. In at least some preferred forms of the training material, not all sequences determined by participant response selections will lead to the either goal, thus building into the system the possibility of failure.

While the majority pf sequences may lead to the achievement of the nominal or actual goal, each sequence attracts a certain value based on the appropriateness of the responses defining the sequnce. Thus the system allows for an element of competition between groups or individual participants and provides a basis for subsequent evaluation and analysis.

In at least some forms of the invention the selection of responses to events presented to the actual participants may be predicated on the decisions made by them in the planning phase. That is to say, some events may only occur if a certain virtual participant, item of supply or equipment had been chosen in the planning phase.

The virtual events encountered by the actual participant's virtual proxies will reflect the sort of difficulties which may have to be faced in a real life adventure type training situation. Thus for example the nominal goal of climbing and descending a mountain may be beset by deteriorating weather, the barrier of a crevasse, the encounter with some dangerous wild animal, a fall and injury and so forth.

The first of the adventure activity phases, that is the reaching of a nominal goal, is intended as a test of, and as a development tool for decision making skills of the actual participants when faced with unexpected and unusual situations and may be seen as analogous to the sort of decisions required in balancing conflicting factors in a business environment, such as for example who is the best person to perform a certain task, what resources can be brought to bear etc.

The object of the second of the two adventure activity phases is to simulate the type of decision making required in a business environment where a primary goal may have been met, for example the initial business plan has achieved a certain desired performance level. However, in the face of ongoing challenges, such as for example, new competitors in the market, technological change and so forth, it now requires an continuing process of strategic decision making to maintain or improve that level of performance.

An advantage of the present invention lies in the fact that the virtual events are controlled, presenting consistent degrees of difficulties for given situations and may be weighted for subsequent statistical analysis.

Where a training system is processed on a personal computer or computer network, suitable software can interact with the DVD or CD ROM presentation to record the decision pathway for analysis and reporting. If required such reporting and analysis material may be password protected so as to make it only available to a training facilitator or other authorized personnel.

For non computer-based systems participants may manually record events and responses as they occur, for example by means of spreadsheets or forms. These could form the basis for self assessment or for subsequent analysis by the training facilitator for use in debriefing and reporting. If desired participants may be given the opportunity to re-evaluate for themselves decisions made at any stage of the training session.

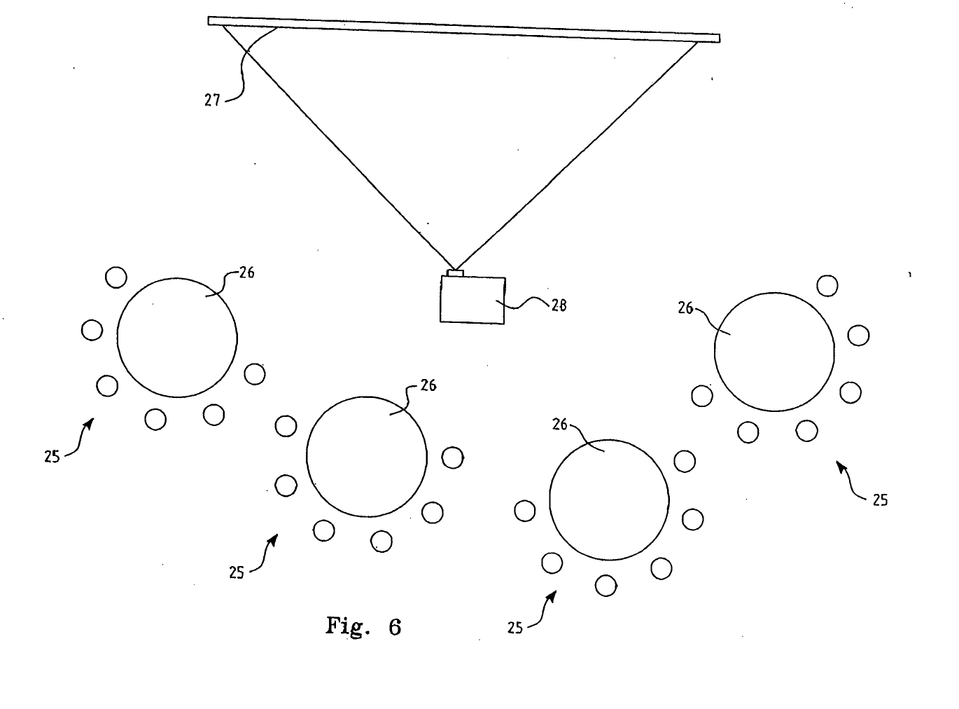

In yet a further preferred embodiment of a training system according to the invention as shown in FIG. 6 a number of participating teams 25 are grouped around tables 26 allowing all teams to view a common display projected onto a screen 27 by for example a data projector 28. In this way teams may be exposed to each other's decision making processes prior to the virtual adventure as well as a recorded replay of the unfolding adventure as a result of that decision process.

The group setting and the interactions between groups as comparisons are made between the various group approaches to the same or similar sets of problems provide an additional valuable training process as well as bringing into focus the quality of team play of individual groups and of team players within the groups.

The above describes only some embodiments of the present invention and modifications, obvious to those skilled in the art, can be made thereto without departing from the scope and spirit of the present invention.

1. A training system adapted to simulate an outdoor adventure type experience through the medium of interactive audio-visual material adapted to present to users of said system sequences of events; said events potentially leading to a predefined nominal goal and a user-selected actual goal, and wherein said users select responses to said events so as to attempt to optimize conditions conducive to the achieving of said nominal goal and said actual goal.

1. The training system of claim 1 wherein said outdoor adventure type experience is a training session, said session comprised of any one of a multiplicity of alternative strings of sequences of events; any one of said strings determined by the selection of one of at least two possible responses by said user to sequential ones of said events.

2. The training system of claim 1 wherein said user is an individual.

3. The training system of claim 1 wherein said user is a group of individuals.

4. The training system of claim 1 wherein said outdoor adventure type experience includes a planning phase wherein said user-selected actual goal is selected from a predetermined group of possible actual goals presented by said system to said user.

5. The training system of claim 5 wherein said planning phase includes the selection by said users of predefined numbers of entities from each of predefined groups of entities, said groups including:
(a) virtual participants to act as proxies for said users,
(b) virtual supplies,
(c) virtual items of equipment.

6. The training system of any one of claims 1 to 6 wherein said audio-visual material is incorporated in a software program adapted for processing on a personal computer.

7. The training system of any one of claims 1 to 6 wherein said audio-visual material is incorporated in a software program adapted for processing on a network of personal computers.

8. The training system of any one of claims 1 to 8 wherein said audio-visual material is in the form of digital data on a Compact Disc Read-Only Memory (CD ROM).

9. The training system of any one of claims 1 to 8 wherein said audio-visual material is in the form of digital data incorporated on a Digital Video Disc (DVD)for display by a data projector.

10. The training system of any one of claims 1 to 6 wherein said audio-visual material is in the form of digital data adapted for processing by a virtual reality system.

11. A method for the training of users utilizing a training system, said training system comprising interactive audio-visual material simulating an outdoor adventure type experience having a predefined set goal and a user-selected goal, said material presented in a planning phase and an execution phase, said method including the steps of:
(a) displaying said material via audio-visual equipment
(b) said users selecting a user-selected goal from a number of predefined goals during said planning phase
(c) said users during said planning phase selecting from predefined groups of entities
(d) the presentation to said users during said execution stage of a sequence of events, each event of said sequence of events accompanied by at least two possible choices of response to said event selectable by said users.

13. The method of claim 12 wherein said groups of entities include:
(a) virtual participants in said outdoor type adventure experience
(b) items of supplies relevant to said outdoor type experience
(c) items of equipment relevant to said outdoor type experience

14. The method of claim 12 wherein each of said sequence of events is one of a multiplicity of possible sequences determined by the selection of said response to each one of said events by said users.

15. The method of claim 13 wherein said selection of said responses determines the realization of said predefined set goal and said user-selected goal.

16. The method of claim 14 wherein said selection of said responses determines the level of achievement of users of said training system.

17. The method of claim 15 wherein each of said selection of said response is recorded for subsequent analysis and feedback to said users.

18. The method of any one of claims 12 to 17 wherein a plurality of groups of participating users are arranged to view on a common display recorded said planning phase and said execution phase of each one of said plurality of groups.
